(19) United States
(12) Patent Application Publication
(10) Pub. No.: US 2023/0288000 A1
(43) Pub. Date: Sep. 14, 2023

(54) MOLDABLE FLUID COUPLERS AND RELATED FLUID CONNECTORS, SYSTEMS AND METHODS

(71) Applicant: CoollT Systems, Inc., Calgary (CA)

(72) Inventors: Vishal Mehmi, Calgary (CA); Bradley Zakaib, Calgary (CA); Seyed Kamaleddin Mostafavi Yazdi, Calgary (CA); Brydon Gierl, Calgary, CA (US)

(21) Appl. No.: 17/689,879

(22) Filed: Mar. 8, 2022

(51) Int. Cl. F16L 21/02; B29C 45/16; B29C 45/00; F16L 21/08

(52) U.S. Cl. CPC F16L 21/02; B29C 45/16; B29C 45/0025; F16L 21/08; B29C 2045/0034; B29L 2023/22

(57) ABSTRACT

A molded fluid coupler defines a continuous external surface and an internal bore extending from a proximal end to a distal end. The molded fluid coupler has an external conduit barb positioned adjacent the proximal end, and a piston positioned adjacent the distal end. The molded fluid coupler also has a proximal rib positioned distally of the conduit barb and a distal rib distally spaced from the proximal rib to define an annular gap positioned between the proximal rib and the distal rib. The piston extends distally of the distal rib and defines an external sealing surface lacking a parting line. In some embodiments, an external surface extending between the proximal end and the barb lacks a parting line.

### FIELD

This application and the subject matter disclosed herein (collectively referred to as the “disclosure”), generally concern fluid couplers, and related fluid connectors, systems and methods. More particularly, but not exclusively, this disclosure pertains to rotatable fluid couplers, fluid connectors incorporating such couplers, and methods of manufacturing such couplers. As but one illustrative example, a disclosed coupler can be molded or cast in a manner that eliminates parting lines from one or more sealing surfaces of the coupler.

### BACKGROUND INFORMATION

Component and overall heat dissipation, together with computing performance, increases with each successive generation of server (including each successive generation of processing component, power-delivery component, chipset component, memory controller component, memory component, and other components within those servers). Consequently, liquid and two-phase cooling technologies are used within data centers and other computing installations (including desktop computers) to efficiently remove heat dissipated by processing units and other heat-generating components.

And, data centers, servers and other computing installations allow only limited space for cooling components to occupy, particularly in close proximity to computing components. Accordingly, most liquid and two-phase cooling systems provide a cold-plate in thermal contact with a heat-generating component, remote heat-exchanger for rejecting heat absorbed by the cold-plate, and fluid conduits to convey heated fluid from the cold-plate to the remote heat-exchanger and to convey cooled fluid from the remote heat-exchanger to the cold-plate.

### SUMMARY

In some respects, concepts disclosed herein generally concern fluid couplers, and related fluid connectors, systems and methods. More particularly, but not exclusively, disclosed principles pertain to rotatable fluid couplers, fluid connectors incorporating such couplers, and methods of manufacturing such couplers. Some embodiments of disclosed principles provide fluid couplers that are physically smaller than prior fluid couplers while providing more reliable fluid connectors (e.g., fluid connectors relatively less-susceptible to leaking than prior connections). Such diminutive fluid couplers allow for more flexibility when designing other cooling-system components because, for example, less of the limited space around heat-generating components is occupied by the fluid couplers.

Further, fluid couplers embodying disclosed principles provide additional advantages over prior-art couplers. For example, disclosed principles enable simpler geometries on sealing surfaces than prior couplers while also being manufacturable in high volumes. As an example, disclosed fluid couplers can be molded or cast in a manner that eliminates parting lines from one or more sealing surfaces of the coupler. And, disclosed principles provide one or more further advantages, such as, for example, shallow or zero draft angles on sealing surfaces and relatively higher compression on o-rings (or other seals or gaskets) than prior couplers provide.

According to a first aspect, a molded fluid coupler defines a continuous external surface and an internal bore extending from a proximal end to a distal end. The molded fluid coupler has an external conduit barb positioned adjacent the proximal end, and a piston positioned adjacent the distal end. The molded fluid coupler also has a proximal rib positioned distally of the conduit barb and a distal rib distally spaced from the proximal rib to define an annular gap positioned between the proximal rib and the distal rib. The piston extends distally of the distal rib and defines an external sealing surface lacking a parting line.

In some embodiments, the proximal rib extends radially outward of and circumferentially around the bore. The distal rib can extend radially outward of and circumferentially around the bore. The proximal rib can have an outer diameter and the distal rib can define a continuous annular wall extending circumferentially around the bore. The annular wall can have an outer diameter less than the outer diameter of the proximal rib.

In some embodiments, the distal rib extends radially outward of and circumferentially around the bore, defining a proximal face positioned opposite the proximal wall and a distal face lacking a parting line. The distal face can define a sealing surface being continuous with the sealing surface of the piston.

Some embodiments of the molded coupler include a shank extending distally from the conduit barb to a proximal surface of the proximal rib. The shank can define a roughened outer surface positioned opposite the bore relative to the shank.

A portion of the external surface between the proximal end of the bore and the conduit barb can have a frustoconical contour. The frustoconical contour can extends from a small outer diameter positioned adjacent the proximal end of the bore to the conduit barb. In some embodiments, the external surface between the proximal end of the bore and the conduit barb lacks a parting line.

The bore can define a first longitudinal axis extending orthogonally from the proximal end and a second longitudinal axis extending orthogonally from the distal end. The first longitudinal axis and the second longitudinal axis can be substantially parallel with each other.

The bore can define a first longitudinal axis extending orthogonally from the proximal end and a second longitudinal axis extending orthogonally from the distal end. The first longitudinal axis can be oriented transversely relative to the second longitudinal axis.

According to another aspect, methods of molding a fluid coupler are disclosed. For example, such a fluid coupler can define a continuous external surface and an internal bore extending from a proximal end to a distal end. The molded fluid coupler can have an external conduit barb positioned adjacent the proximal end, a piston positioned adjacent the distal end, a proximal rib positioned distally of the conduit barb and a distal rib distally spaced from the proximal rib to define an annular gap positioned between the proximal rib and the distal rib. The piston can extend distally of the distal rib. According to an exemplary method, a first cavity defined by a first mold can be filled with a moldable material. The first cavity can correspond to the piston extending distally of the distal rib and a portion of the distal rib contiguous with the piston. A second cavity can be filled with the moldable material. The second cavity can be defined by a second mold and a third mold in registration with each other. The second cavity can correspond to the external conduit barb, the proximal rib and the annular gap. The first cavity and the second cavity can be continuous with each other when the first mold is positioned in registration with the second mold and the third mold. The method can also include slidably withdrawing the piston from the first cavity. The piston and the portion of the distal rib contiguous with the piston, after being withdrawn from the first cavity, lack a longitudinally extending parting line.

In some embodiments, disclosed methods also include withdrawing the external conduit barb, the proximal rib and the annular gap from the second cavity and the third cavity. At least a portion of the external surface of the fluid coupler other than the piston can define a longitudinally extending parting line.

In some embodiments, a fourth mold can define a corresponding fourth cavity corresponding to a portion of the coupler extending from the proximal end to the barbed portion, and the barbed portion can be withdrawn from the fourth cavity without a parting line having been formed on the sealing surface. In another embodiment, the act of withdrawing the external conduit barb, the proximal rib and the annular gap from the second cavity and the third cavity can include separating the second mold from the third mold.

The distal rib can define a proximal face, a distal face, and a circumferentially extending outer surface spanning longitudinally from the proximal face to the distal face, with the portion of the distal rib being contiguous with the piston including the distal face. The distal rib can define a circumferential parting line positioned proximally of the distal face corresponding to an interface between the first mold and the second mold. The acts of filling the first cavity with the moldable material and filling the second cavity with the moldable material can give rise to the circumferential parting line.

According to yet another aspect, a fluid connector includes a fluid coupler defining a continuous external surface and an internal bore extending from a proximal end to a distal end. The fluid coupler includes an external conduit barb positioned adjacent the proximal end and a piston positioned adjacent the distal end. The fluid coupler also has a proximal rib positioned distally of the conduit barb and a distal rib distally spaced from the proximal rib to define an annular gap positioned between the proximal rib and the distal rib. The piston extends distally of the distal rib and defines an external sealing surface lacking a parting line. The fluid connector also includes a socket having an internal contour complementary with and corresponding to the external surface of the molded fluid coupler. The housing also defines a transverse bore having a longitudinal axis that, when the distal end of the molded fluid coupler mates with the socket, extends transversely relative to the annular gap between the proximal rib and the distal rib. An o-ring extends circumferentially around and urges radially inwardly against the external sealing surface of the piston. The distal rib defines a distal face and the o-ring is positioned distally of the distal face. A retainer has a longitudinally extending body sized to slidably mate with the transverse bore defined by the housing. The retainer, when slidably mated within the transverse bore, extends through the annular gap, inhibiting longitudinal movement of the molded fluid coupler relative to the socket.

In some embodiments, the internal bore of the molded fluid coupler has a segment corresponding to the piston and defines a first longitudinal axis. The socket can have a recessed floor and the housing can also define a second bore open through the recessed floor. The second bore can have a second longitudinal axis. The first longitudinal axis can align with the second longitudinal axis when the distal end of the molded fluid coupler mates with the socket.

In some embodiments, the socket is recessed within the housing and the housing defines a second bore open to the socket to convey liquid to or from the molded fluid coupler when the distal end of the molded fluid coupler mates with the socket. The socket can define a first recessed region having an internal surface complementarily contoured relative to the external sealing surface of the piston.

The internal surface of the first recess can define a first lower face and a perimeter wall can extend around the first lower face. The second bore can open through the first lower face.

The second bore can define a corresponding longitudinal axis and the first recess of the socket can define a corresponding longitudinal axis. The longitudinal axis of the second bore and the longitudinal axis of the first recess can be substantially aligned with each other.

The second bore can define a corresponding longitudinal axis and the first recess of the socket can define a corresponding longitudinal axis. The longitudinal axis of the second bore and the longitudinal axis of the first recess can be offset from each other.

The second bore open through the first lower face can define an opening through the first lower face. The opening through the first lower facing can have a perimeter. The first lower face can extend laterally outward of a portion of the perimeter, defining a shoulder.

The socket can define a second recessed region defining a second lower face. A second perimeter wall can extend around the second lower face. The first recessed region can open through the second lower face. The fluid connector can also include a collar having an outer surface so complementarily contoured relative to the perimeter wall of the first recessed region as to be slidably receivable within the first recessed region. The collar can have an internal surface so complementarily contoured relative to the piston that the piston is slidably receivable within the collar.

When first recessed region slidably receives the collar and the collar slidably receives the piston, the bore opening from the distal end of the fluid coupler can fluidically couple with the second bore open to the socket.

When first recessed region slidably receives the collar and the collar slidably receives the piston, the bore opening from the distal end of the fluid coupler can be eccentrically positioned relative to the second bore open to the socket.

The socket can define a second recessed region defining a lower face and a perimeter wall extending around the lower face of the second recessed region. The first recessed region can open through the lower face of the second recessed region.

The internal surface of the first recess can define a first lower face and a perimeter wall can extend around the first lower face. The second bore can open through the first lower face and the perimeter wall of the first lower face can be recessed from the lower face of the second recessed region.

The distal rib of the molded fluid coupler can define a distal face that opposes the lower face of the second recessed region when the distal end of the molded fluid coupler mates with the socket. The lower face of the second recessed region, the external sealing surface of the piston and the distal face of the distal rib together can define a gland for the o-ring when the distal end of the molded fluid coupler mates with the socket.

When the distal end of the molded fluid coupler mates with the socket, the second bore of the housing can fluidically couple with the internal bore of the molded fluid coupler, defining a conduit for liquid extending between the housing and the molded fluid coupler.

When the conduit contains pressurized liquid, the o-ring can sealingly engage at least the perimeter wall of the second recessed region, the external sealing surface of the piston and the distal face of the distal rib, inhibiting leakage of the liquid from the conduit extending between the housing and the molded fluid coupler.

The bore can define a first longitudinal axis extending orthogonally from the proximal end and a second longitudinal axis extending orthogonally from the distal end. The first longitudinal axis and the second longitudinal axis can be substantially parallel with each other.

The bore can define a first longitudinal axis extending orthogonally from the proximal end and a second longitudinal axis extending orthogonally from the distal end. The first longitudinal axis can be oriented transversely relative to the second longitudinal axis.

The socket can be a first socket, the housing can define a second socket and an internal fluid passage can fluidical couple the first socket with the second socket.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 illustrates an exploded view of prior-art fluid connectors for a cooling module.

FIG. 2 illustrates a partially exploded, isometric view of a fluid connector.

FIG. 3A illustrates an isometric view of a fluid coupler as in FIG. 2.

FIG. 3B illustrates an isometric view of another fluid coupler as in FIG. 2.

FIG. 4 illustrates a partially exploded, side-elevation view of a fluid connector as in FIG. 2.

FIG. 5 illustrates a fluid connector as in FIG. 2.

FIG. 6 illustrates a side-elevation view of a cross-section of the fluid connector in FIG. 5, taken along line VI-VI.

FIG. 7A illustrates an isometric view of a straight fluid coupler embodiment. FIG. 7B illustrates a plan view from above the fluid coupler shown in FIG. 7A.

FIG. 8A illustrates an isometric view of a fluid coupler embodiment having a 20-degree elbow. FIG. 8B illustrates a plan view from above the fluid coupler shown in FIG. 8A.

FIG. 9A illustrates an isometric view of a fluid coupler embodiment having a 45-degree elbow. FIG. 9B illustrates a plan view from above the fluid coupler shown in FIG. 9A.

FIG. 10A illustrates an isometric view of a fluid coupler embodiment having a 70-degree elbow. FIG. 10B illustrates a plan view from above the fluid coupler shown in FIG. 10A.

FIG. 11A illustrates an isometric view of a fluid coupler embodiment having a 90-degree elbow. FIG. 11B illustrates a plan view from above the fluid coupler shown in FIG. 11A.

FIG. 12A illustrates an isometric view of a plugged fluid coupler embodiment. FIG. 12B illustrates a plan view from above the fluid coupler shown in FIG. 12A.

FIG. 13 illustrates the socket shown in FIG. 6.

FIG. 14 illustrates a partially exploded view of another embodiment of a fluid connector in cross-section as in FIG. 6.

FIG. 15 illustrates an isometric view of the fluid coupler and collar shown in FIG. 14.

FIG. 16 illustrates a partially exploded view of another embodiment of a fluid connector in cross-section as in FIG. 6.

FIG. 17 illustrates an isometric view of the fluid coupler and collar shown in FIG. 16.

FIG. 18 illustrates a partially exploded view of another embodiment of a fluid connector in cross-section as in FIG. 6.

FIG. 19 illustrates an isometric view of the fluid coupler and collar shown in FIG. 18.

FIG. 20 illustrates a partially exploded view of another embodiment of a fluid connector in cross-section as in FIG. 6.

FIG. 21 illustrates an isometric view of the fluid coupler and collar shown in FIG. 20.

FIG. 22 illustrates isometric, end-elevation and side-elevation view of a collar as in FIGS. 18 and 19.

FIG. 23A illustrates a plan view from above a tee-shaped embodiment of a disclosed fluid connector. FIG. 23B illustrates a side-elevation view of the embodiment shown in FIG. 23A.

FIG. 24A illustrates a plan view from above a prior-art tee-shaped fluid connector. FIG. 24B illustrates a side-elevation view of the tee-shaped fluid connector shown in FIG. 24A.

FIG. 25 illustrates a prior art plugged fluid connector.

FIG. 26 is a photograph showing a working embodiment of a disclosed fluid coupler (bottom) compared to a prior art fluid coupler (top).

FIG. 27A schematically illustrates an intermediate stage of a disclosed manufacturing process, e.g., for a fluid coupler as in FIG. 3A.

FIG. 27B schematically illustrates an intermediate stage of a disclosed manufacturing process, e.g., for a fluid coupler as in FIG. 3B.

FIG. 28 schematically illustrates several acts in a disclosed manufacturing process.

### DETAILED DESCRIPTION

The following describes various principles pertaining to fluid couplers, and related fluid connectors, systems and methods. That said, descriptions herein of specific apparatus configurations and combinations of method acts are but particular examples of the variety of contemplated embodiments, chosen as being convenient to illustrate disclosed principles. One or more of the disclosed principles can be incorporated in various other embodiments to achieve any of a variety of corresponding system characteristics.

Thus, embodiments of disclosed principles having attributes that are different from those specific embodiments discussed herein can embody one or more presently disclosed principles, and can be used in applications not described herein in detail. Accordingly, such alternative embodiments also fall within the scope of this disclosure.

### I. Overview

Embodiments of disclosed fluid couplers, and related fluid connectors, systems and methods can be incorporated in a wide variety of fluidic devices and systems to improve reliability of fluidic connections between components compared to prior-art fluid couplers. Further, disclosed fluid couplers have a less-complex physical geometry compared to prior-art fluid couplers and can thus readily be manufactured using existing molding or casting techniques. To enhance apprehending the significance of presently disclosed fluid couplers, the following provides a brief overview of prior fluid couplers and several corresponding long-felt but unmet needs associated with them.

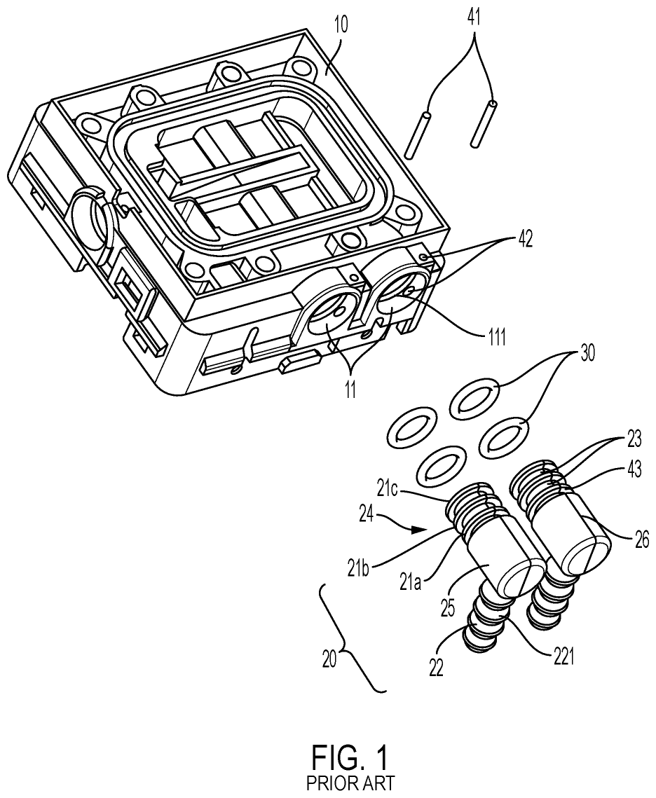

FIG. 1 shows an exploded view of a fluid assembly including a housing 10 for a cooling device and two prior art fluid couplers 20. U.S. Pat. No. 10,274,266, issued Apr. 30, 2019, describes such cooling devices and is hereby incorporated in its entirety for all purposes to the same extent as if fully reproduced herein.

Referring still to FIG. 1, the housing 10 defines a pair of sockets 11, each being configured to receive an insertable piston 24 defined by one of the fluid couplers 20. As shown, each piston 24 extends distally away from a body portion 25 and defines several longitudinally spaced-apart, annular ribs 21 that define annular gaps (or grooves) 23, 43 therebetween. The fluid couplers 20 have hollow interiors through which fluid (e.g., a liquid-phase, a gas-phase, or a saturated mixture thereof) can pass. In the illustrated devices, an internal bore extends from a proximal end of the conduit shank 22 to a distal end of the piston 24, allowing fluid to pass from the distal end to the proximal end, and vice-versa.

More specifically, each piston 24 defines a proximal rib 21a spaced apart from the body 25, defining a proximal annular gap (or groove) 43 positioned between a distally-oriented face (not shown) of the body and a proximally-oriented face of the proximal rib 21a. Further, each piston 24 defines a second (medial) rib 21b distally spaced apart from the proximal rib 21a, defining a medial annular gap (or groove) 23 positioned between a distally-oriented face (not shown) of the proximal rib 21a and a proximally-oriented face of the medial rib 21b. The medial annular gap defines a gland for a first O-ring 30, which can be seated in the medial gap between the proximal and medial ribs 21a, 21b. Still further, each piston 24 defines a third (distal) rib 21c distally spaced apart from the medial rib 21b, defining a distal annular gap (or grove) 23 positioned between a distally-oriented face (not shown) of the medial rib 21b and a proximally-oriented face of the distal rib 21c. The distal annular gap similarly defines a gland for a second O-ring 30, which can be seated in the distal gap between the medial and distal ribs 21b, 21c.

Each coupler 20 also has a conduit shank 22 extending from the body portion 25 for engaging a fluid conduit (not shown). The conduit shank 22 also defines a plurality of external barbs 221 that resist axial sliding of the fluid conduit (not shown) away from the body portion 25 after the shank 22 is inserted into the conduit. The shank 22 defines an internal bore (not shown) providing a first segment of a fluid passage through the coupler 20. As well, the body portion 25 and the piston 24 define a second segment of the fluid passage through the coupler.

When the piston 24 is inserted into a corresponding socket 11, the bore through the piston fluidically couples with an internal fluid passage defined by the housing 10. Further, the O-rings urge against an interior surface 111 of the socket, compressing into the gland and sealing against one or more of the surfaces defining the annular gap. Further, a bore 42 defined by the housing can align with and extend transversely relative to the proximal gap 43. A pin 41 inserted into the bore 42 can thus extend transversely through the proximal gap 43 between the distally-oriented face of the body portion and the proximally-oriented face of the proximal rib 21a. The pin 41 thusly inserted through the gap 43 can inhibit translation (e.g., further insertion or withdrawal) of the piston 24 relative to the socket 11, as the proximally-oriented face of proximal rib 21a will urge against the pin 41 as a withdrawal force is applied to the coupler 20 and the distally-oriented face of the body portion 25 will urge against the pin 41 as an insertion force is applied to the coupler 20. Nonetheless, the arrangement of the pin 41 within the annular gap 43 will permit the coupler 20 to rotate around a longitudinal axis of the piston 24.

The prior art couplers 20 can be readily manufactured using a molding or a casting technique. For example, a first mold can define a first cavity corresponding to a portion, e.g., one half, of the coupler 20 and a second mold can define a second cavity corresponding to another portion, e.g., the other half, of the coupler 20. When the first mold and the second mold are brought together, the first cavity and the second cavity combine to form a single cavity that can be filled with a suitable material (e.g., molten HDPE). After the material cures or otherwise hardens in the combined mold, the first mold and the second mold can be withdrawn from each other and the molded or cast coupler 20 can be removed from the molds.

But as a by-product of such molding or casting process, some of the material used to fill the combined cavity will also tend to seep into interstitial voids between the first mold and the second mold, leading to so-called “flash” around a perimeter of the coupler 20. Although such flash can be removed, it will typically leave behind a so-called parting line 26. A parting line is typically a slightly raised rib (or a depressed recess) relative to a major surface of the molded or cast part. Accordingly, when an O-ring is seated in a gland 23, the parting line 26 extends transversely relative to the O-ring (i.e., longitudinally of the piston 24), which can provide a path through which a pressurized fluid (liquid, gas or a saturated mixture thereof) can seep or leak past the O-ring. With fluid couplers having a rib at or near a distal end of the piston 24, e.g., as with the rib 21c, this inherent limitation (i.e., longitudinal parting lines) of molding and casting processes will remain.

That is to say, forming an annular rib at or near a distal end (or more particularly, a recess positioned between a proximal end and a distal end) of the coupler can result in the molded coupler interlocking with the mold feature that defines the distal rib/proximal recess. For example, a cavity in a single-part mold will require under-cut regions that, when filled with molded material, cannot be removed from the mold without sacrificing either the molded part or the mold. By contrast, a split or otherwise partitioned mold as described above can permit each mold component to slidably retract laterally from the piston 24 (i.e., laterally relative to the piston's longitudinal axis). However, as discussed above, partitioned molds give rise to parting lines on the resulting molded component, which in turn can cause or promote undesirable fluid leakage.

Principles described herein, including the specific embodiments of disclosed fluid couplers, can eliminate parting lines and other imperfections from sealing surfaces without requiring secondary machining or finishing operations. Thus, disclosed principles solve a long-felt but unmet need of reducing complexity and improving reliability of fluid connectors across a variety of applications.

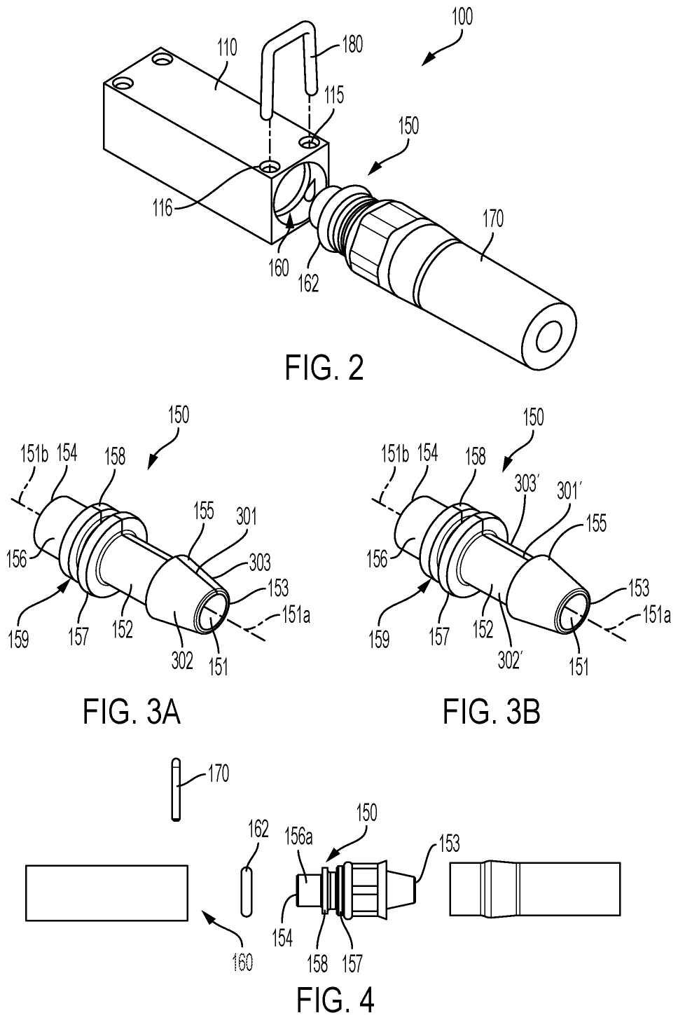

For example, as FIGS. 2 and 3 show, a molded fluid coupler can define a continuous external surface and an internal bore extending from a proximal end to a distal end, similar to prior couplers. However, unlike prior fluid couplers, disclosed fluid couplers have a piston positioned adjacent the distal end, a proximal rib positioned proximally of the distal end, leaving a portion of the piston extending distally of the rib. This arrangement permits the distally oriented face of the rib and the external sealing surface of the piston to be molded or cast while eliminating any parting line from those sealing surfaces. Parting lines can be eliminated because a distal portion of the rib and the distally extending portion of the piston can be removed from a mold cavity by longitudinally (e.g., parallel to a longitudinal axis of the fluid coupler) sliding the mold and molded coupler apart from each other. Accordingly, the external sealing surfaces of the piston and the distally oriented face of the rib can be molded or cast within a cavity defined by a single-piece mold (or die), eliminating the seam between split molds required by prior couplers and into which moldable material can flow.

By eliminating parting lines or other defects from sealing surfaces, the quality and reliability of the fluid-tight interface between the coupler and a socket that receives the coupler are improved because a leading source of leakage is eliminated. Accordingly, a redundant O-ring used with the prior coupler can be eliminated from disclosed couplers, while maintaining or improving overall reliability of the fluid-tight connection between the coupler and the receiving socket.

Referring now to FIG. 2 through FIG. 6, an embodiment of a fluid connector can provide means for connecting a conduit to a fluid device, allowing fluid to flow through the conduit to or from the fluid device. For example, as described in U.S. Pat. No. 10,274,266, supra, such a fluid device can be, for example, a cold-plate for cooling a heat-generating component (e.g., a central processing unit or a graphics processing unit). That being said, disclosed fluid connectors and their features can be incorporated in a wide variety of other system embodiments, as discussed more fully below, to provide a fluid coupling between devices.

The illustrated fluid connector 100 includes a fluid coupler 150 that can be partially seated within or against a socket 160 and held in place by one or more retainers 180. To enhance sealing the interface between the fluid coupler 150 and the socket 160, an O-ring 162 or other gasket member extends around a portion of the coupler 150. When the coupler is seated within or against the socket, the O-ring sealingly engages a surface of the coupler and an opposed surface of the socket, inhibiting or preventing pressurized fluid from seeping or leaking through the interface.

Other, related principles also are disclosed. For example, the following describes additional features of coupler embodiments, features of complementary sockets and selected method acts that can be adopted when manufacturing disclosed couplers.

### II. Fluid Couplers

FIGS. 2, 3A, 3B, 4 and 6 illustrate aspects of a molded fluid coupler 150, 150′ now described. Features common between the couplers shown in FIGS. 3A and 3B share common reference numerals and features in FIG. 3B that are similar but not identical to features in FIG. 3A are identified by a superscript “′” (also sometimes referred to as a “prime” symbol). The molded coupler 150, 150′ defines a continuous external surface and an internal bore 151 extending from a proximal end 153 to a distal end 154 (FIG. 4). The molded fluid coupler 150, 155′ has an external conduit barb 155, 155′ positioned adjacent the proximal end 153, 153′ and a piston 156 positioned adjacent the distal end 154. A proximal rib 157 is positioned distally of the conduit barb 155, 155′ and a distal rib 158 is distally spaced from the proximal rib 157 to define an annular gap 159 positioned between the proximal rib and the distal rib. The piston 156 extends distally of the distal rib 158 and defines an external sealing surface 156a lacking a parting line.

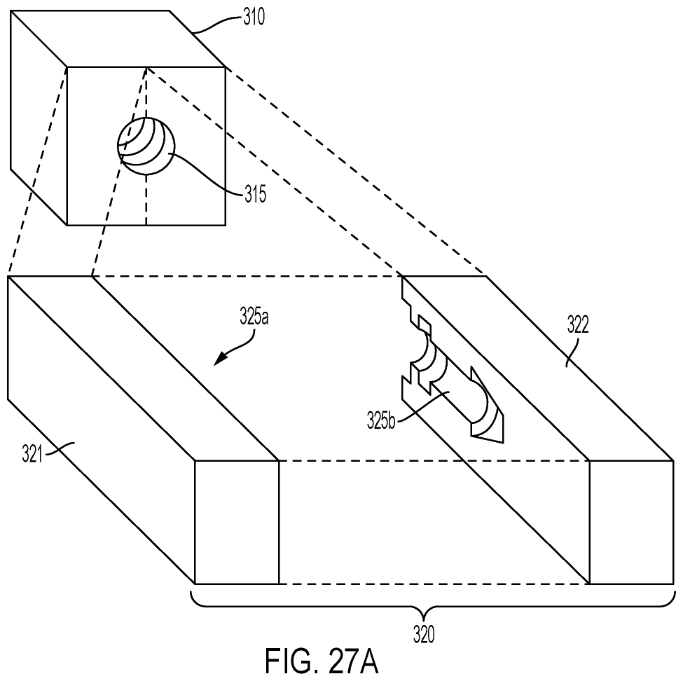

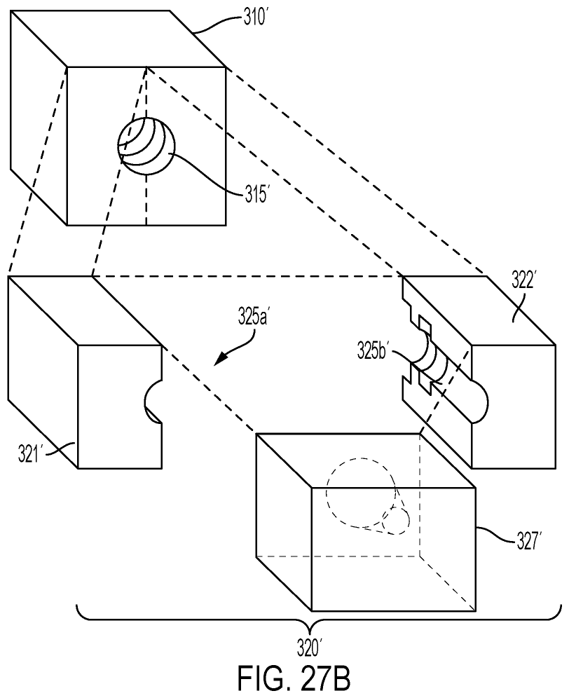

As briefly noted, the parting line 26 (FIG. 1) spanning across one or more sealing surfaces of prior couplers can be eliminated with a fluid coupler as shown in FIGS. 2, 3, 4 and 6 because the piston 156 and a distal portion 158a of the distal rib 158 can be slidably withdrawn from a mold cavity defined by a single-piece mold (or die). See, for example, FIGS. 27A and 27B, and the related discussion below. For example, in FIG. 3A, the external sealing surfaces of the piston 156 and the distal face 158a of the distal rib 158 lack any recesses or protrusions (other features) that would tend to lock the coupler 150 within the mold 310 shown in FIGS. 27A and 27B. By contrast, the annular gap 159 between the ribs would tend to lock the coupler 150 within that single-piece mold. Accordingly, a two-or-more piece mold (or die) would likely be used to make the portions of the coupler that are between the distal rib 158 and the proximal end 153 of the coupler, which would tend to introduce a parting line 301 on an external surface of the coupler proximal of the distal rib 158. In FIG. 3B, by contrast, the parting line 301′ terminates at the barbed portion 155, altogether eliminating a parting line from the sealing surface of the molded fluid coupler 150′. FIG. 27B schematically illustrates a multi-part die suitable for molding the coupler 150′ in FIG. 3B.

The illustrated proximal rib 157 (FIG. 3A, 3B) extends radially outward of and circumferentially around the bore 151. Similarly, the distal rib 158 can extend radially outward of and circumferentially around the bore, as shown.

In the illustrated embodiments, the proximal rib 157 has an outer diameter Dₚ and the distal rib 158 define a continuous annular wall extending circumferentially around the bore 151, defining an outer diameter D_{d} less than the outer diameter of the proximal rib (FIG. 6). In other coupler embodiments, the distal rib has a same diameter or a larger diameter compared to that of the proximal rib. That being said, a stiff distal rib having a same or smaller diameter compared to that of the proximal rib can allow both ribs to be in close proximity to or to seat against a fixed-position internal wall 161 of a socket 160 (FIG. 6) that receives the coupler. (On the other hand, if the distal rib can resiliently deform or if the socket wall can resiliently deform as a relatively larger distal rib passes through a proximal region of the socket, then the distal rib can have a relatively larger diameter than that of the proximal rib.)

Although the couplers 150, 150′ are shown as being longitudinally axisymmetric (e.g., generally circular, cylindrical, conical or frustoconical), other embodiments of couplers (e.g., as in FIGS. 8A through 11B) can be symmetric about a selected longitudinally extending plane and asymmetric relative to another longitudinally extending plane. Still other couplers (not shown) lack any longitudinal symmetry. Nonetheless, such alternative couplers can still be formed without a parting line on any sealing surfaces using principles disclosed herein, as with the couplers 150, 150′.

The illustrated distal rib (and the alternative distal ribs described above and elsewhere) defines a proximal face 158b positioned opposite the proximal rib 157, as well as a distal face 158a oriented opposite the proximal face. The distal face 158a in each of these embodiments can lack a parting line. For example, the distal face 158a can define a sealing surface that is continuous with the sealing surface 156a of the piston 156. As FIG. 4 shows, these smooth sealing surfaces 156a, 158a of the piston that omit a parting line allow the O-ring 162 to seat against them, sealingly engaging with the surfaces without being lifted off a region of the sealing surface by a parting line, flash or other remnant from a molding process and without requiring secondary machining or other finishing operations applied to the molded (or cast) coupler. Similarly, the smooth sealing surface of the barbed portion 155′ that omits a parting line allows a hose or other conduit to seat against it, sealingly engaging with an inner conduit surface without being lifted off a region of the sealing surface by a parting line, flash or other remnant from a molding process and without requiring secondary machining or other finishing operations applied to the molded (or cast) barb to remove the parting line.

The illustrated fluid couplers 150, 150′ also have a shank 152 extending distally from the conduit barb 155, 155′ to a proximal surface 157a of the proximal rib 157. In some embodiments, the shank 152 defines a roughened outer surface. In other words, the external surface of the shank (positioned opposite the bore relative to a wall of the shank) can be roughened (e.g., knurled) to enhance a user's grip on the coupler when inserting the piston 156 in a socket and/or when inserting the barbed portion in a conduit 170.

A portion of the external surface of the coupler between the proximal end 153 of the bore 151 and the conduit barb 155, 155′ can have a frustoconical contour, as shown. For example, the frustoconical contour can extend from a small outer diameter positioned adjacent the proximal end of the bore to the conduit barb. In other embodiments, the external surface of the coupler can have a longitudinal curvature (e.g., a parabolic curvature) from the small outer diameter positioned adjacent the proximal end of the bore to the conduit barb. In these and the illustrated embodiments, the barbed coupler can be molded using a mold as in FIG. 27B to eliminate a parting line from the sealing surface extending from the proximal end 153 to the barb 155′.

The fluid couplers 150, 155′ shown in FIGS. 2 through 6 provide a straight bore, and thus a straight fluid connection, passing from the proximal end 153 to the distal end 154. For example, the illustrated bore 151 defines a first longitudinal axis 151a extending orthogonally from the proximal end 153 and a second longitudinal axis 151b extending orthogonally from the distal end 154. With the fluid couplers 150, 150′ shown in FIGS. 2 through 6, the first longitudinal axis 151a and the second longitudinal axis 151b are substantially coextensive with each other. In other embodiments, the longitudinal axes 151a, 151b may not be coextensive with other but may still be substantially parallel with each other, such as, for example, in an embodiment where one end of the coupler is laterally offset from the opposed end of the coupler.

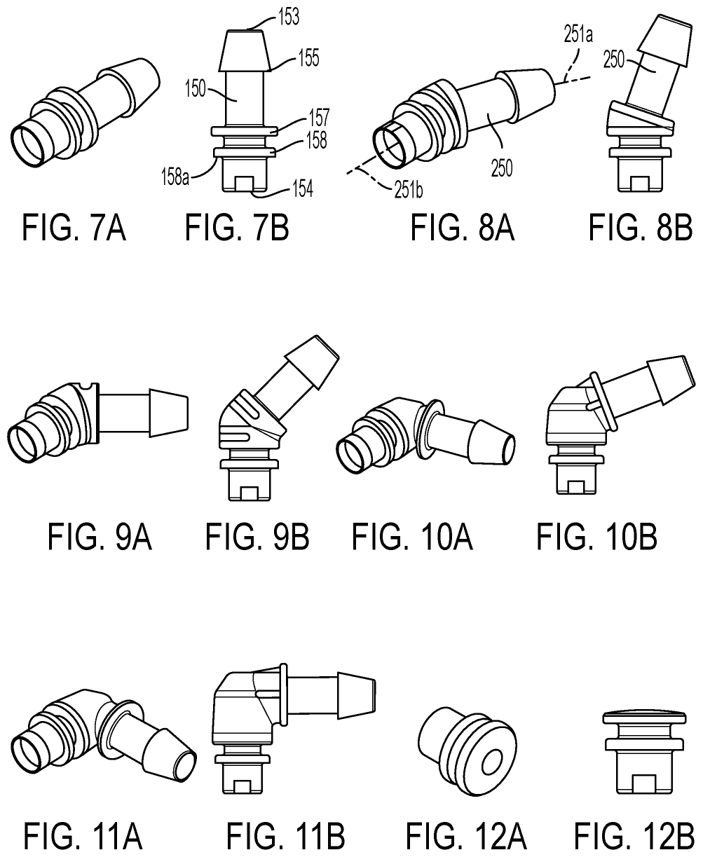

In still other embodiments, (e.g., as with embodiments shown in FIG. 7A through FIG. 11B, for example), the fluid coupler provides an elbow connection that changes flow direction between the proximal end and the distal end. Nonetheless, these alternative embodiments eliminate the parting line from one or both of the sealing surfaces of the barb 155′ and the piston 154 (though no parting lines are shown in FIG. 7A through FIG. 11B for clarity of illustration and explanation). For example, the coupler 250 shown in FIGS. 8A and 8B has a bore that defines a first longitudinal axis 251a extending orthogonally from the proximal end and a second longitudinal axis 251b extending orthogonally from the distal end, and the first longitudinal axis is oriented transversely relative to the second longitudinal axis. The coupler in FIGS. 8A and 8B provides a 20-degree change in flow direction between the proximal end and the distal end. The couplers shown among FIGS. 9A and 11B provide, for example, 45-degree, 70-degree and 90-degree changes in direction. Other embodiments of disclosed fluid couplers provide other (e.g., more or less) changes in flow direction.

In some embodiments, as in FIGS. 12A and 12B, the coupler lacks an open internal bore and thus plugs or prevents fluid from passing through the coupler. Such plug embodiments can be useful when filling or draining a fluid device. For example, some fluid devices provide a fill (or drain) port configured as a socket (e.g., similar to the socket 160 shown in FIG. 2) that opens to an internal fluid passage. In such fluid devices, the fill (or drain) port is not designed to provide a fluid connection to another device during normal operation, but rather to provide access to the fluid circuit during filling or draining operations.

### III. Fluid Connectors

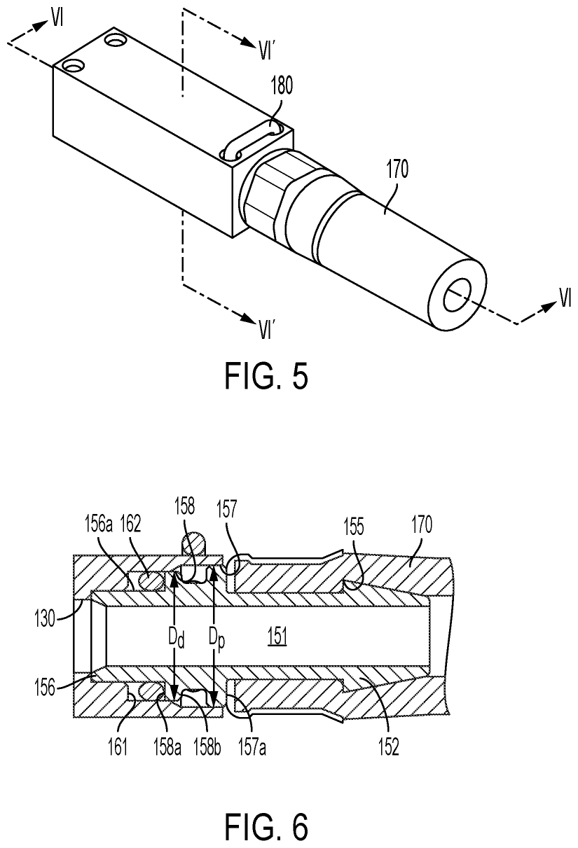

FIGS. 2, 4, 5 and 6 illustrate an embodiment of a fluid connector that incorporates a fluid coupler as described above. The illustrated fluid connector 100 includes the fluid coupler 150, 150′ and a socket 160, as well as the O-ring 162 that sealingly engages with the sealing surfaces of the fluid coupler and the socket when the connector 100 is assembled, as in FIGS. 5 and 6. The double-legged retainer 180 is but one possible embodiment of a suitable retainer for maintaining the mating engagement of the fluid coupler within the socket. For instance, individual pins 41 (FIG. 1) can be uses in lieu of the double legged retainer.

In the illustrated embodiment, a housing 110 defines the socket 160. For example, the housing 110 defines an external wall 112 and an open recess 114 from the wall 112. The open recess 114 has an internal sidewall 120 that has a contour complementary with and corresponding to the external surface of the molded fluid coupler 150, 150′ (FIGS. 3A, 3B).

The illustrated housing 110 also defines a first transverse bore 115 and a second transverse bore 116, each of which has a longitudinal axis. Each leg of the double-legged retainer 180 (or each elongate pin 41) can be inserted into one of the transverse bores 115, 116 and can slide along the longitudinal axis until the leg (or pin) is seated (or slidably mated) within the bore (e.g., as in FIG. 5). When the distal end 154 of the illustrated fluid couplers 150, 150′ mate with the socket 160, each leg of the retainer 180 (or pin 41) extends transversely relative to the annular gap 159 and is positioned between the proximal rib 157 and the distal rib 158, inhibiting or preventing the fluid coupler 150, 150′ from being withdrawn from the socket 160 or inserted further into the socket. For example, under a withdrawing force, the distal rib 158 of the coupler 150, 150′ tends to urge against the retainer 180 or the pin 41, and under a further insertion force, the proximal rib 157 of the couplers tends to urge against the leg or the pin.

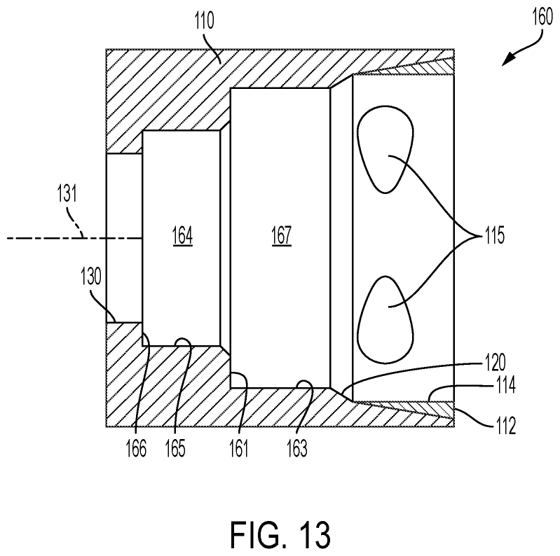

In the illustrated embodiment, the O-ring 162 extends circumferentially around the piston head 156 proximal to the sealing surface 158a of the distal rib 158. The illustrated O-ring is annular with a circular cross-section, though other cross-sectional shapes are possible. Further, other than annular seals can be suitable for providing a sealing engagement between the outer surface of the piston 156 and the inner surface of the socket 160. Generally speaking, an inner contour of the seal 162 so corresponds to the outer contour of the piston 156 as to sealingly engage with the outer surface of the piston. For example, if the piston is shaped as a rectangular prism, a suitable shape of the interior bore of the seal could be rectangular. In most embodiments, the inner contour is slightly undersized relative to the piston, allowing the seal to resiliently expand to receive the piston within the seal. For example, in the illustrated embodiment, the inner diameter of the O-ring 162 is slightly undersized relative to the outer diameter of the piston 156, causing the inner surface of the O-ring to urge radially inwardly against the external sealing surface of the piston. Similarly, an outer dimension of the seal (or O-ring in the illustrated embodiment) may be slightly oversized relative to interior dimension of the socket, which will tend to cause the seal to urge outwardly against the internal sealing surface 163 of the socket 160 (FIG. 13). With such an arrangement, the O-ring (or seal) sealingly engages with the outer surface of the piston and with the internal surface of the socket.

The socket 160 and the fluid coupler 150, 150′ can have complementary features that allow the coupler to matingly engage with the socket. As shown in the cross-sectional views of FIG. 6 and FIG. 13, the socket 160 is recessed within the housing 110. For example, the illustrated socket 160 defines a first recessed region 164 having an internal surface complementarily contoured relative to the external sealing surface 156a of the piston 156. As shown in FIG. 6, the first recessed region can receive a distal portion of the piston 156.

More particularly, as FIG. 13 shows, the internal surface of the first recessed region 164 defines a first lower face 166 and a perimeter wall 165 extending around the first lower face 166. In FIG. 6, the distal end 154 of the fluid coupler 150 is positioned opposite the first lower face 166, and the perimeter wall 165 extends around a the sealing surface 156a defined by the distal portion of the piston 156. The coupler 150′ can be similarly fitted with the socket 150. The illustrated socket 160 (FIG. 13) also defines a second recessed region 167 defining a second lower face 161 and a second perimeter wall 163 extending around the second lower face 161. The first recessed region 164 opens through the second lower face 161, defining a shoulder that extends around and outward of the first perimeter wall 165.

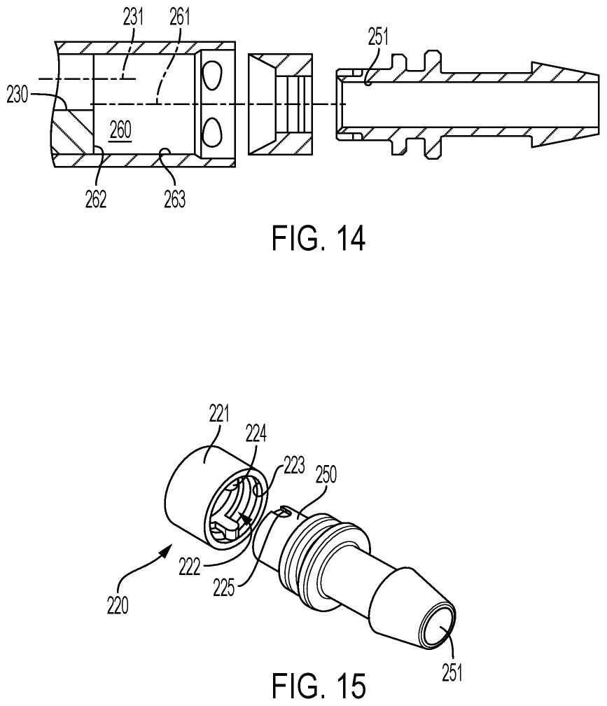

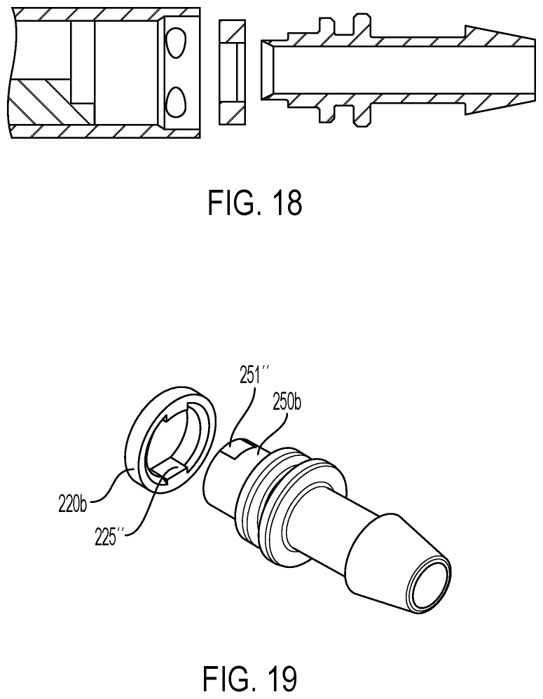

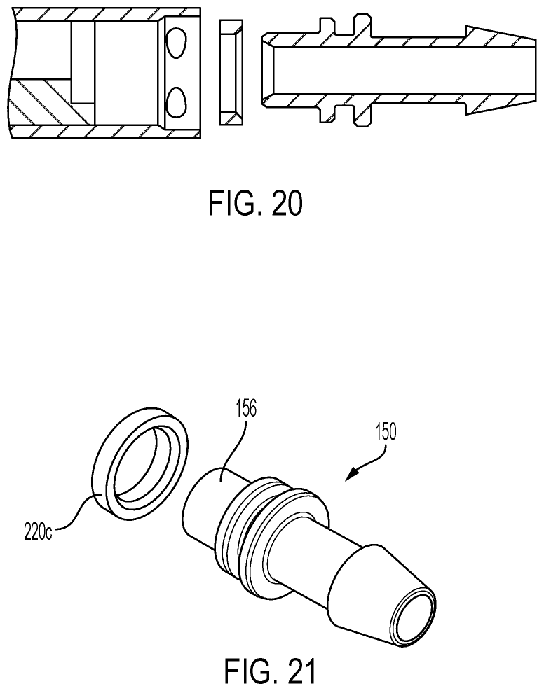

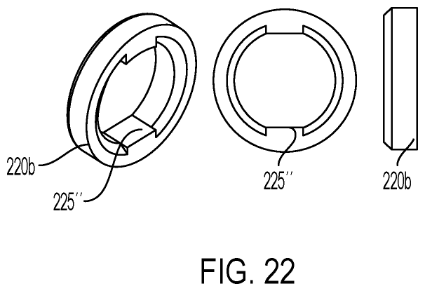

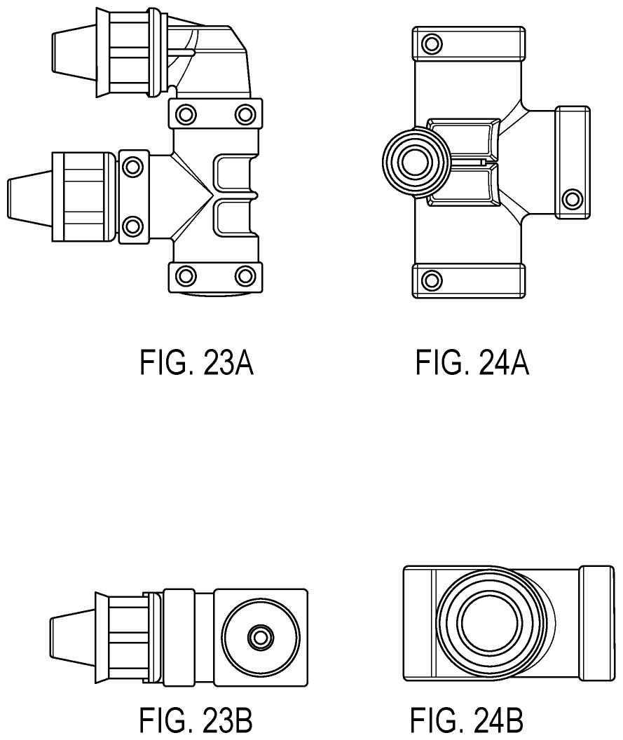

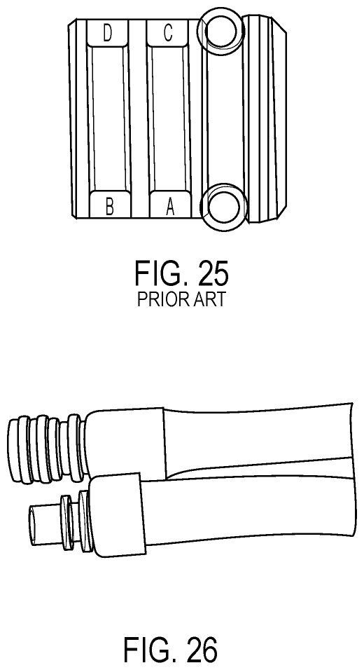

As FIGS. 6 and 13 show, the illustrated housing 110 defines a second bore 130 open to the socket 160 to convey liquid to or from the molded fluid coupler 150 when the distal end 154 of the molded fluid coupler mates with the socket. Although the following description of FIGS. 5 and 13 (as well as FIGS. 14, 16, 18, 19, and 20) refers to the molded coupler 150, it applies equally to the molded coupler 150′. More specifically, the illustrated housing's bore 130 opens through the first lower face 166 of the socket. In this embodiment, the internal bore 151 of the molded fluid coupler 150 can align with the bore 130 of the housing, fluidically coupling them together and providing a continuous fluid passageway from the housing 110 to the fluid coupler 150, and vice-versa. As FIG. 3 shows, a segment of the bore through the fluid coupler 150 that corresponds to the piston 156 can define a first longitudinal axis 151b. As well, the second bore 130 defined by the housing 110 can define a longitudinal axis 131 (FIG. 13) that aligns with the first longitudinal axis 151b when the distal end 154 of the molded fluid coupler 150 mates with the socket 160. For example, the longitudinal axis of the second bore and the longitudinal axis of the first recess can be coextensive with each other, parallel with each other (or otherwise offset from each other), or can intersect with each other. In some embodiments, the longitudinal axes are substantially parallel, coextensive, or intersecting with each other, and only offset from each a small amount, e.g., arising from installation misalignment or manufacturing tolerances.

Returning to FIG. 6, the distal rib 158 of the molded fluid coupler 158 defines a distal face 158a that opposes the lower face 161 of the second recessed region when the distal end of the molded fluid coupler mates with the socket. The lower face 161 of the second recessed region 167, the external sealing surface 156a of the piston 156 and the distal face 158a of the distal rib 158 together define a gland for the O-ring 162 when the distal end of the molded fluid coupler mates with the socket. As explained above, when the distal end 154 of the molded fluid coupler 150 mates with the socket 160, a conduit extends across the housing 110 and the fluid coupler 150. When this conduit contains pressurized liquid, the O-ring 162 tends to sealingly engage with one or more of the perimeter wall 163 of the second recessed region 167, the external sealing surface 156a of the piston 156 and the distal face 158a of the distal rib 158, inhibiting leakage of the liquid from the conduit.

In the embodiment shown in FIGS. 6 and 13, the housing's bore 130 defines a corresponding longitudinal axis 131 and the first recess 164 of the socket 160 defines a corresponding longitudinal axis that are aligned with each other (save perhaps for differences arising from manufacturing tolerances). In other embodiments, as shown in FIGS. 14, 16, 18 and 20, the longitudinal axis 231 of the housing's bore 230 and the longitudinal axis 261 of the first recess 260 are laterally offset from each other. In these embodiments, the lower face 262 of the first recess can extend laterally outward of only a portion of the bore 230 (or it can extend outwardly of all of the bore, albeit in an eccentric arrangement).

With such an offset bore 230, disclosed fluid connectors can include a collar (e.g., an annular collar) that acts as an adapter for a fluid coupler as shown in FIG. 6. For example, FIG. shows a collar 220 having an external surface 221 and an open interior 222 defining an internal surface 223. The first recess 260 of the socket shown in FIG. 14 can slidably receive the collar 220 in a manner that the external surface 221 of the collar mates with the interior surface 263 of the perimeter wall. The internal surface 223 of the collar 220 can be so complementarily contoured relative to the piston 250 that the piston is slidably receivable within the collar, as indicated in the exploded views of FIGS. 14, 16, 18, and 20. For example, in FIGS. 15 and 17, the internal surface 223, 223′ of the collar 220, 220a includes a boss 224, 224′ that mates with a corresponding slot 225, 225′ defined by the piston 250, 250′. FIG. 19 shows a collar 220b that includes a different boss 225″ that mates with a corresponding land-pad 251″ defined by piston 250b. FIG. 21 shows a collar 220c that has a circular interior that can receive the piston 156 of the coupler 150. When the socket slidably receives the collar 220, 220a and the collar slidably receives the piston 250, 250′ of the fluid coupler, the bore 251 opening from the distal end of the fluid coupler can fluidically couple with the housing's bore 230, 230′ that opens to the socket. Nonetheless, in such an arrangement, the bore 251 opening from the distal end of the fluid coupler is eccentrically positioned relative to the housing's bore 230, 230′.

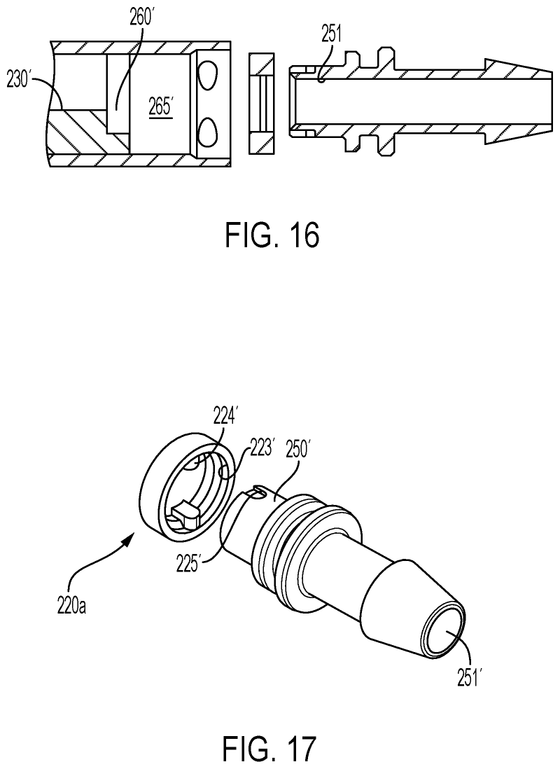

In embodiments that align the housing's bore with the bore through the fluid coupler (e.g., as in FIG. 6 and FIG. 13) and in embodiments where the bores are fluidically coupled yet eccentrically arranged (as in FIGS. 14, 16, 18 and 20), the socket can define a second recessed regio, e.g., a region that has a larger cross-section than the first recessed region. For example, the second recessed region 167 shown in FIGS. 6 and 13 defines a lower face 161 and a perimeter wall 163 extending around the lower face. In this embodiment, the first recessed region 164 opens through the lower face 161 of the second recessed region 167. Although the recessed regions of the socket are shown co-centrically aligned with each other, other embodiments (e.g., in FIG. 16) can place the recessed regions 260′, 265′ of the socket in an eccentric arrangement with each other.

Although the housings shown among FIGS. 6, 13, 14, 16, 18 and 20 have a single socket, those of ordinary skill in the art will understand and appreciate that a fluid device may incorporate more than one socket for conveying fluid into or out of the fluid device. For example, a fluid device can provide an inlet socket to convey liquid into the fluid device and an outlet socket to discharge liquid from the fluid device. And, other fluid devices may have more than one inlet socket, more than one outlet socket, or more that one of each in a single device. In all of these embodiments, a molded fluid coupler as described herein can be used in combination with such sockets and fluid devices.

For example, FIG. 23A and FIG. 23B show a tee-joint that includes three disclosed sockets as in FIG. 2. Depending on the system in which the tee-joint is installed, the tee-connection can have one inlet and two outlets, or two inlets and one outlet. FIGS. 23A and 23B also show a fluid coupler matingly engaged with two of the three sockets.

Fluid connectors described herein can be smaller than prior fluid connectors. For example, FIGS. 24A and 24B show a prior-art tee-joint (having sockets as in FIG. 1) but without prior-art fluid couplers installed. A visual comparison of FIGS. 23A and 24A show that disclosed fluid connectors (e.g., tee-joint and fluid coupler) can be about the same size or only slightly larger than just the prior-art tee-joint. FIG. 26 also shows that a disclosed fluid coupler (bottom) can be significantly smaller than a prior-art fluid coupler (top).

### IV. Manufacturing Methods

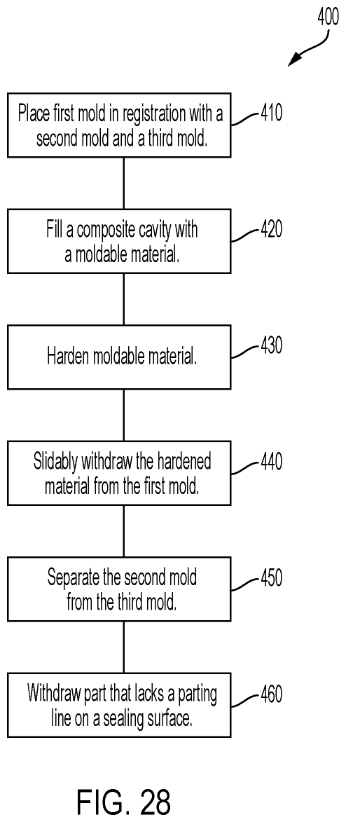

Referring now to FIGS. 27A, 27B and 28, methods of manufacturing a fluid coupler as described above are described. As noted, some embodiments of such fluid couplers can be molded or cast in a manner that eliminates parting lines or other remnants of molding or casting from a sealing surface. Although many manufacturing techniques can be used to achieve such results, e.g., through secondary machining or finishing processes, these results can also be achieved directly from a molding or casting process. For example, a first mold 310, 310′ (FIG. 27A, 27B) can define a first cavity 315, 315′ corresponding to a portion of the piston 156 and/or a distal portion of the distal rib 158 (FIGS. 3A, 3B). A split mold 320, 320′ can have a first die 321, 321′ and a second die 322, 322′. Each die, in turn, can define a cavity 325a, 325a′ (die 321, 321′) and 325b, 325b′ (die 322, 322′) corresponding to one-half of the portion of the fluid coupler 150, 150′ that is proximal of the distal rib 158. For instance, the cavity 325a, 325a′ of the first die 321, 321′ can correspond to a left-half 302, 302′ (FIG. 3A, 3B) of the fluid coupler 150, 150′ and the cavity 325b, 325b′ of the second die 322, 322′ can correspond to a right-half 303, 303′ of the fluid coupler. As the first and second dice 321, 322 (321′, 322′) are brought together, their respective cavities can combine to define a single cavity that corresponds to the portion of the coupler proximal of the distal rib 158. The first mold 310 in FIG. 27A (which corresponds to the piston and distal face of the distal rib) can also be combined with the first and second dice so that the cavities 315, 325a, 325b combine into a single cavity. Notably, with this arrangement, any parting lines 301 (FIG. 3) that might arise from the molding process will be proximal of all sealing surfaces of the piston 156 and the distal rib 158.

FIG. 27B shows another mold arrangement for molding a fluid coupler that lacks a parting line from each sealing surface, as shown and described by way of example in relation to FIG. 3B. As with the die shown in FIG. 27a, the mold 320′ in FIG. 28B has a first mold 310 (which corresponds to the piston and distal face of the distal rib) can be combined with the first die 321′ and second die 322′ so that the cavities 315′, 325a′, and 325b′ combine into a single cavity. However, the mold 320′ includes a fourth die 327′ that defines a recessed region (shown as a hidden line) corresponding to the tapered sealing surface proximal of the barb 155′ defined by the coupler 150′ (FIG. 3B). The recessed region of the fourth die 327′ permits the tapered sealing surface of the coupler 150′ to be slidably withdrawn from a single die, eliminating a parting line from the tapered sealing surface proximal of the barb 155′. Accordingly, a mold arranged as in FIG. 27B eliminates any parting lines 301 (FIG. 3B) from a sealing surface and restricts them to locations distal of the barb 155′ to the distal rib 158.

Referring now to FIG. 28, a manufacturing process 400 is described. The first cavity 315 defined by the first mold 310, which corresponds to the piston extending distally of the distal rib and a portion of the distal rib contiguous with the piston, can be placed in registration with a second mold 321 and a third mold 322, at method act 410. The cavity in the second and third molds can correspond to the external conduit barb 155, the proximal rib 157 and the annular gap 159 between the proximal rib and the distal rib. Moreover, the second cavity 325a and the third cavity 325b can be continuous with each other when the second mold 321 is positioned in registration with the third mold 322. When the first mold is placed in registration with the second and the third molds, the first cavity can be continuous with the combined second and third cavities, defining a composite cavity that can be filled with moldable material, at method act 420. The material can harden at method act 430. Once the moldable material hardens, cures, or otherwise solidifies within the cavities, the piston can be slidably withdrawn from the first cavity, at method act 440. After being withdrawn from the first cavity, the piston and the portion of the distal rib contiguous with the piston can lack a longitudinally extending parting line. The second and third molds (or dice) can be split apart at method act 450, and the external conduit barb, the proximal rib and the annular gap of the coupler can be withdrawn from the second cavity and the third cavity at method act 460. Although removable with secondary machining or finishing operations, at least a portion of the external surface of the fluid coupler other than the piston and a sealing surface of the distal rib can define a longitudinally extending parting line, e.g., parting line 301 in FIG. 3. And, a circumferential parting line (not shown) may be present on a portion of the distal rib 158 as a consequence of the joint between the first mold and the assembled second and third molds, albeit not on the sealing surface 158a.

The illustrated method shown in FIG. 28 can be extended to use with the mold shown in FIG. 27B, as by modifying act 410 to include placing the first mold in registration with the second mold and the third mold, and placing a fourth mold in registration with the second mold and the third mold. Act 440 can also be expanded to also include slidably withdrawing the hardened material from the fourth mold.

### V. Other Embodiments

The embodiments of disclosed principles described above generally concern fluid couplers for fluidic devices and systems.

Nonetheless, the previous description is provided to enable a person skilled in the art to make or use the disclosed principles. Embodiments other than those described above in detail are contemplated based on the principles disclosed herein, together with any attendant changes in configurations of the respective apparatus or changes in order of method acts described herein, without departing from the spirit or scope of this disclosure. Various modifications to the examples described herein will be readily apparent to those skilled in the art.

Several examples of fluidic devices and systems that can benefit from embodiments of disclosed principles include liquid cooling systems for electronics, two-phase cooling systems for electronics, single-phase and two-phase HVAC systems for buildings, water-distribution systems for agriculture, chemical distribution systems for industrial process. The foregoing examples are selected simply to illustrate the wide variety of applications for disclosed principles; the list of examples is not and is not intended to be exhaustive.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features and acts claimed herein. Accordingly, neither the claims nor this detailed description shall be construed in a limiting sense, and following a review of this disclosure, those of ordinary skill in the art will appreciate the wide variety of fluid couplers and fluid connectors, and related systems and methods that can be devised using the various concepts described herein.

Moreover, nothing disclosed herein is intended to be dedicated to the public regardless of whether such disclosure is explicitly recited in the claims. No claim feature is to be construed under the provisions of 35 USC 112(f), unless the feature is expressly recited using the phrase “means for” or “step for”.

The appended claims are not intended to be limited to the embodiments shown herein, but are to be accorded the full scope consistent with the language of the claims, wherein reference to a feature in the singular, such as by use of the article “a” or “an” is not intended to mean “one and only one” unless specifically so stated, but rather “one or more”. Further, in view of the many possible embodiments to which the disclosed principles can be applied, we reserve the right to claim any and all combinations of features and technologies described herein as understood by a person of ordinary skill in the art, including the right to claim, for example, all that comes within the scope and spirit of the foregoing description, as well as the combinations recited, literally and equivalently, in any claims presented anytime throughout prosecution of this application or any application claiming benefit of or priority from this application, and more particularly but not exclusively in the claims appended hereto.

We currently claim:

1. A molded fluid coupler defining a continuous external surface and an internal bore extending from a proximal end to a distal end, the molded fluid coupler comprising an external conduit barb positioned adjacent the proximal end, a piston positioned adjacent the distal end, a proximal rib positioned distally of the conduit barb and a distal rib distally spaced from the proximal rib to define an annular gap positioned between the proximal rib and the distal rib, the piston extending distally of the distal rib and defining an external sealing surface lacking a parting line.

2. The molded fluid coupler according to claim 1, wherein the proximal rib extends radially outward of and circumferentially around the bore.

3. The molded fluid coupler according to claim 2, wherein the distal rib extends radially outward of and circumferentially around the bore.

4. The molded fluid coupler according to claim 3, wherein the proximal rib has an outer diameter and the distal rib defines a continuous annular wall extending circumferentially around the bore, the annular wall having an outer diameter less than the outer diameter of the proximal rib.

5. The molded fluid coupler according to claim 1, wherein the distal rib extends radially outward of and circumferentially around the bore, defining a proximal face positioned opposite the proximal wall and a distal face lacking a parting line.

6. The molded fluid coupler according to claim 5, wherein the distal face defines a sealing surface being continuous with the sealing surface of the piston.

7. The molded fluid coupler according to claim 1, further comprising a shank extending distally from the conduit barb to a proximal surface of the proximal rib.

8. The molded fluid coupler according to claim 7, wherein the shank defines a roughened outer surface positioned opposite the bore relative to the shank.

9. The molded fluid coupler according to claim 1, wherein a portion of the external surface between the proximal end of the bore and the conduit barb has a frustoconical contour.

10. The molded fluid coupler according to claim 9, wherein the frustoconical contour extends from a small outer diameter positioned adjacent the proximal end of the bore to the conduit barb.

11. The molded fluid coupler according to claim 1, wherein the bore defines a first longitudinal axis extending orthogonally from the proximal end and a second longitudinal axis extending orthogonally from the distal end, wherein the first longitudinal axis and the second longitudinal axis are substantially parallel with each other.

12. The molded fluid coupler according to claim 1, wherein the bore defines a first longitudinal axis extending orthogonally from the proximal end and a second longitudinal axis extending orthogonally from the distal end, wherein the first longitudinal axis is oriented transversely relative to the second longitudinal axis.

13. A method of molding a fluid coupler, the fluid coupler defining a continuous external surface and an internal bore extending from a proximal end to a distal end, the molded fluid coupler comprising an external conduit barb positioned adjacent the proximal end, a piston positioned adjacent the distal end, a proximal rib positioned distally of the conduit barb and a distal rib distally spaced from the proximal rib to define an annular gap positioned between the proximal rib and the distal rib, the piston extending distally of the distal rib, the method comprising:
filling a first cavity defined by a first mold with a moldable material; the first cavity corresponding to the piston extending distally of the distal rib and a portion of the distal rib contiguous with the piston;
filling a second cavity with the moldable material, the second cavity defined by a second mold and a third mold in registration with each other, the second cavity corresponding to the external conduit barb, the proximal rib and the annular gap, the first cavity and the second cavity being continuous with each other when the first mold is positioned in registration with the second mold and the third mold; and
slidably withdrawing the piston from the first cavity, wherein the piston and the portion of the distal rib contiguous with the piston, after being withdrawn from the first cavity, lack a longitudinally extending parting line.

14. The method according to claim 13, further comprising withdrawing the external conduit barb, the proximal rib and the annular gap from the second cavity and the third cavity, wherein at least a portion of the external surface of the fluid coupler other than the piston defines a longitudinally extending parting line.

15. The method according to claim 14, wherein the act of withdrawing the external conduit barb, the proximal rib and the annular gap from the second cavity and the third cavity comprises separating the second mold from the third mold.

16. The method according to claim 13, wherein the distal rib defines a proximal face, a distal face, and a circumferentially extending outer surface spanning longitudinally from the proximal face to the distal face, the portion of the distal rib being contiguous with the piston comprising the distal face, wherein the distal rib defines a circumferential parting line positioned proximally of the distal face corresponding to an interface between the first mold and the second mold, wherein the acts of filling the first cavity with the moldable material and filling the second cavity with the moldable material give rise to the circumferential parting line.

17. A fluid connector, comprising:
a fluid coupler defining a continuous external surface and an internal bore extending from a proximal end to a distal end, the fluid coupler comprising an external conduit barb positioned adjacent the proximal end, a piston positioned adjacent the distal end, a proximal rib positioned distally of the conduit barb and a distal rib distally spaced from the proximal rib to define an annular gap positioned between the proximal rib and the distal rib, the piston extending distally of the distal rib and defining an external sealing surface lacking a parting line;
a socket having an internal contour complementary with and corresponding to the external surface of the molded fluid coupler, the housing further defining a transverse bore having a longitudinal axis that, when the distal end of the molded fluid coupler mates with the socket, extends transversely relative to the annular gap between the proximal rib and the distal rib;
an o-ring extending circumferentially around and urging radially inwardly against the external sealing surface of the piston, the distal rib defining a distal face and the o-ring positioned distally of the distal face; and
a retainer having a longitudinally extending body sized to slidably mate with the transverse bore defined by the housing, wherein the retainer, when slidably mated within the transverse bore, extends through the annular gap, inhibiting longitudinal movement of the molded fluid coupler relative to the socket.

18. The fluid connector according to claim 17, wherein the internal bore of the molded fluid coupler has a segment corresponding to the piston and defines a first longitudinal axis, wherein the socket has a recessed floor and the housing further defines a second bore open through the recessed floor, the second bore having a second longitudinal axis, wherein the first longitudinal axis aligns with the second longitudinal axis when the distal end of the molded fluid coupler mates with the socket.

19. The fluid connector according to claim 17, wherein the socket is recessed within the housing and the housing defines a second bore open to the socket to convey liquid to or from the molded fluid coupler when the distal end of the molded fluid coupler mates with the socket, wherein the socket defines a first recessed region having an internal surface complementarily contoured relative to the external sealing surface of the piston.

20. The fluid connector according to claim 19, wherein the internal surface of the first recess defines a first lower face and a perimeter wall extending around the first lower face, the second bore open through the first lower face.

21. The fluid connector according to claim 20, wherein the second bore defines a corresponding longitudinal axis and the first recess of the socket defines a corresponding longitudinal axis, wherein the longitudinal axis of the second bore and the longitudinal axis of the first recess are substantially aligned with each other.

22. The fluid connector according to claim 20, wherein the second bore defines a corresponding longitudinal axis and the first recess of the socket defines a corresponding longitudinal axis, wherein the longitudinal axis of the second bore and the longitudinal axis of the first recess are offset from each other.

23. The fluid connector according to claim 20, wherein the second bore open through the first lower face defines an opening through the first lower face, the opening through the first lower facing having a perimeter, wherein the first lower face extends laterally outward of a portion of the perimeter, defining a shoulder.

24. The fluid connector according to claim 23, wherein the socket defines a second recessed region defining a second lower face and a second perimeter wall extending around the second lower face, the first recessed region open through the second lower face, the fluid connector further comprising a collar having an outer surface so complementarily contoured relative to the perimeter wall of the first recessed region as to be slidably receivable within the first recessed region, the collar further having an internal surface so complementarily contoured relative to the piston that the piston is slidably receivable within the collar.

25. The fluid connector according to claim 24, wherein, when first recessed region slidably receives the collar and the collar slidably receives the piston, the bore opening from the distal end of the fluid coupler fluidically couples with the second bore open to the socket.

26. The fluid connector according to claim 24, wherein, when first recessed region slidably receives the collar and the collar slidably receives the piston, the bore opening from the distal end of the fluid coupler is eccentrically positioned relative to the second bore open to the socket.

27. The fluid connector according to claim 19, wherein the socket defines a second recessed region defining a lower face and a perimeter wall extending around the lower face of the second recessed region, the first recessed region open through the lower face of the second recessed region.

28. The fluid connector according to claim 27, wherein the internal surface of the first recess defines a first lower face and a perimeter wall extending around the first lower face, the second bore open through the first lower face and the perimeter wall of the first lower face recessed from the lower face of the second recessed region.

29. The fluid connector according to claim 27, wherein the distal rib of the molded fluid coupler defines a distal face that opposes the lower face of the second recessed region when the distal end of the molded fluid coupler mates with the socket, wherein the lower face of the second recessed region, the external sealing surface of the piston and the distal face of the distal rib together define a gland for the o-ring when the distal end of the molded fluid coupler mates with the socket.

30. The fluid connector according to claim 29, wherein, when the distal end of the molded fluid coupler mates with the socket, the second bore of the housing fluidically couples with the internal bore of the molded fluid coupler, defining a conduit for liquid extending between the housing and the molded fluid coupler.

31. The fluid connector according to claim 30, wherein, when the conduit contains pressurized liquid, the o-ring sealingly engages at least the perimeter wall of the second recessed region, the external sealing surface of the piston and the distal face of the distal rib, inhibiting leakage of the liquid from the conduit extending between the housing and the molded fluid coupler.

32. The molded fluid coupler according to claim 17, wherein the bore defines a first longitudinal axis extending orthogonally from the proximal end and a second longitudinal axis extending orthogonally from the distal end, wherein the first longitudinal axis and the second longitudinal axis are substantially parallel with each other.

33. The molded fluid coupler according to claim 17, wherein the bore defines a first longitudinal axis extending orthogonally from the proximal end and a second longitudinal axis extending orthogonally from the distal end, wherein the first longitudinal axis is oriented transversely relative to the second longitudinal axis.

34. The molded fluid coupler according to claim 17, wherein the socket is a first socket, the housing defining a second socket and an internal fluid passage fluidically coupling the first socket with the second socket.
